(19) United States
(12) Patent Application Publication
(10) Pub. No.: US 2026/0109563 A1
(43) Pub. Date: Apr. 23, 2026

(54) SPLICING DEVICE FOR SPLICING BAND STRIPS, IN PARTICULAR ADHESIVE CORD BAND STRIPS

(71) Applicant: Fischer TireTech Germany GmbH, Burgkunstadt (DE)

(72) Inventor: Frank SCHMIDT, Thurnau (DE)

(21) Appl. No.: 19/363,986

(22) Filed: Oct. 21, 2025

(30) Foreign Application Priority Data
Oct. 23, 2024 (DE) 10 2024 130 831.1

(51) Int. Cl. B65H 21/00; B65H 7/02

(52) U.S. Cl. CPC B65H 21/00; B65H 7/02; B65H 2301/4189; B65H 2701/391

(57) ABSTRACT

A device for splicing band strips, including a conveyor belt transporting a first band portion, a splicing apparatus including a splicing unit that splices a leading edge of a band strip on the conveyor belt with a trailing edge of a previously spliced band strip. A transport belt transports the spliced band strip. A sensor device detects a position of the conveyed band strip for aligning the conveyed band strip and the spliced band with an alignment device. The sensor device has a first sensor for detecting the position of a longitudinal edge of the band strip. A control device determines a lateral offset of the detected position of the longitudinal edge relative to the position of the longitudinal edge of the spliced band, and, when an offset is determined, controls a drive of the splicing apparatus, which is displaceable transversely to the conveying direction of the conveyor belt, in order to align the two longitudinal edges.

### CROSS-REFERENCE TO RELATED APPLICATIONS

The present application claims priority of DE 10 2024 130 831.1, filed Oct. 23, 2024, the priority of this application is hereby claimed, and this application is incorporated herein by reference.

### BACKGROUND OF THE INVENTION

The invention relates to a splicing device for splicing band strips, in particular adhesive cord band strips, comprising
a conveyor belt transporting a first band portion,
a splicing apparatus comprising a splicing unit in which a leading edge of a band strip conveyed over the conveyor belt is spliced with a trailing edge of a previously spliced band strip to form a spliced band strip, and comprising a transport belt for transporting the spliced band strip,
and a sensor device for detecting a position of at least the conveyed band strip, based on which the conveyed band strip and the spliced band strip can be aligned with each other by means of an alignment device.

Such a splicing device, as known for example from DE 10 2017 120 262 B4, is used for example in the tire industry to produce a continuous band from individual band strips made of an adhesive cord band material, for which purpose the individual band strips are spliced together along one edge by means of a splicing apparatus. Such a splicing apparatus has, for example, a splicing tool by means of a splicing head or several splicing heads. The splicing head or heads are fed from above to the edges that have been positioned relative to each other beforehand. After the splicing heads have been placed in position, they are pulled over the band material linearly along the splicing line, in a pressed state, over the band material in the direction of the lateral band edges. The splicing heads can run loosely or can be driven. When pulled over the band material, the latter is compacted and thus spliced. In this way, an endless band can be produced by splicing together a large number of individual band strips, as is required, for example, for the production of belt strips for a tire.

The individual band strips are first cut in a cutting device from a cord band coming from an unwinding station, in which the initial band wound into a roll is stored, and is transported to the splicing apparatus via a conveyor belt, wherein the geometry of the individual band portions regularly has a parallelogram-like shape, i.e., a leading tip and a trailing tip, as well as a leading edge and a trailing edge at an angle to the conveying direction and two longitudinal edges running parallel to the conveying direction. After cutting, the band strips cut in the cutting device are transferred to a conveyor belt, which transports them to the splicing apparatus, where a leading edge of a conveyed band portion is spliced to a trailing edge of a band portion previously spliced to the endless band. It is important that the band strips to be spliced together are correctly positioned in relation to each other, with the longitudinal edges in particular being aligned with each other so that the finished endless band does not have any lateral edge offset. In order to avoid such offset, the splicing device known from DE 10 2017 120 262 B4 provides a sensor device that makes it possible to detect information about the position of the band strip being conveyed and to determine how one of the two longitudinal edges of the band strip being conveyed is positioned and to what extent there is any offset of the longitudinal edge of the conveyor band strip being conveyed relative to the longitudinal edge of the band strip previously spliced. If such an offset is detected, in the known splicing device, the conveyed band strip is gripped at its longitudinal edge by means of an alignment device comprising a clamping device that can be moved along the conveyor belt and, during transport, is pulled laterally by means of the accompanying alignment device into the desired position, in which the longitudinal edge is aligned as well as possible with that of the previously spliced band portion. Although such an alignment device allows the conveyed band strip to be aligned well, it is relatively complex in design and operation.

An alternative method for aligning a conveyed band strip is known from DE 601 01 962 T2. There, before a cut band strip is transferred to the conveying direction leading to the splicing apparatus a sensor device is used to detect position information about the band strip and, based on this, the center line of the band strip, which is to be aligned with the center line of the previously spliced band strip, i.e., the endless band. Alignment is achieved by pivoting the conveyor device, which is pivoted at its end adjacent to the splicing apparatus, so that the transfer position of the conveyed band strip is adjusted in the pivot position and the center lines are aligned. In addition, the splicing table on which the end of the previously spliced endless band lies can also be moved laterally. Position detection takes place well before the actual splicing plane, which is not conducive to precise alignment, as position changes may still occur over the longer conveyor distance on the conveyor belt, and the position of the center line, relative to which the alignment is performed, is not measured but only calculated, which is also not conducive to precise alignment.

### SUMMARY OF THE INVENTION

The invention addresses the problem of providing an improved splicing device.

To solve this problem, the invention provides that a splicing device of the type mentioned above comprises a sensor device with a first sensor apparatus arranged at a longitudinal position of the conveyor belt, which is designed to detect the position of a longitudinal edge of the band strip, wherein a control device is provided which is designed to determine a lateral offset of the detected position of the longitudinal edge with respect to the position of the longitudinal edge of the spliced band strip, and via which, when an offset is determined, a drive means of the splicing apparatus, which is mounted so as to be displaceable transversely to the conveying direction of the conveyor belt, can be controlled to align the two longitudinal edges.

The splicing device according to the invention provides a sensor device comprising a first sensor apparatus arranged at a longitudinal position of the conveyor belt. This first sensor apparatus is used to detect the exact position of a longitudinal edge of the band strip in relation to a reference edge, i.e., the lateral position of the longitudinal edge as given on the front device. This means that the longitudinal edge is actually detected, and the alignment is performed with respect to this edge, i.e., the longitudinal edge of the band portion and the longitudinal edge of the spliced band are aligned with each other. The sensor device communicates with a control device which is capable of determining any lateral offset between the detected position of the longitudinal edge of the conveyed band strip and the known position of the longitudinal edge of the spliced band. This means that the actual lateral offset between two longitudinal edges is determined. If such an offset exists, the control devices activate a drive means which moves the splicing apparatus transversely to the conveying direction of the conveyor belt so that the two longitudinal edges are aligned with each other. This means that, according to the invention, the end of the spliced band resting on the splicing apparatus is aligned with the conveyed band strip, or rather the longitudinal edge of the spliced band is aligned with the longitudinal edge of the conveyed band strip. Since the position of the longitudinal edge of the conveyed strip is detected on the conveyor belt itself, i.e., shortly before the actual transfer of the band strip to the splicing apparatus, the actual position, as it is quasi present at the longitudinal edge during splicing, is known, so that optimal edge alignment in the splicing plane is possible. There are no significant position changes with regard to the edge position on the short conveyor section from the detection point to the splicing point, so that optimal alignment of the longitudinal edge of the spliced endless band can be achieved based on this position information. To do this, the splicing apparatus itself must be moved slightly laterally, i.e., transversely to the conveying direction, meaning that the splicing apparatus itself acts as the alignment device. Since the band end rests in a fixed position on the splicing apparatus, this fixed band end, which does not move during the alignment process, is aligned, which enables extremely precise alignment, as only a transverse displacement occurs and there is no movement of the band itself.

The determination, according to the invention, of the longitudinal edge position of the conveyed band at or on the conveying direction itself, i.e., shortly before the actual splicing location, as well as the alignment of the non-moving band end of the endless band and thus its longitudinal edge with respect to the moving longitudinal edge of the conveyed strip by simply moving the splicing apparatus allows for significantly better alignment of the longitudinal edges with each other, which are aligned with each other as well as possible after splicing.

In a development of the invention, the sensor device may comprise a second sensor apparatus which is arranged at a longitudinal position of the conveyor belt downstream of the first sensor apparatus in the conveying direction, adjacent to the end of the conveyor belt, and which is also designed to detect the position of a longitudinal edge of the band strip, wherein the control device is designed to determine a lateral offset of the position of the longitudinal edge detected by the second sensor apparatus with respect to the position of the longitudinal edge of the spliced band and to control the drive means when an offset is detected. The sensor device therefore comprises a second sensor apparatus which, viewed in the conveying direction of the conveyor belt, is positioned closer to the splicing apparatus, namely adjacent to the end of the conveyor belt, i.e. almost immediately before the band strip is transferred to the splicing apparatus. This second sensor apparatus is used to detect the position of the longitudinal edge of the conveyed band strip again, wherein this position information is fed to the control devices, which use this information to determine any offset again. The actual position of the longitudinal edge of the conveyed band strip is therefore determined at two offset positions. This means that a two-stage alignment is possible. As soon as the position has been detected by the first sensor apparatus, the control devices can immediately activate the drive means after determining any offset and move the splicing apparatus laterally to compensate for the offset. This allows a kind of pre-control of the splicing apparatus, which is moved to an aligned first position based on this first position detection. If further position information is detected with the second sensor apparatus, this can correspond to the first position information detected via the first sensor apparatus. This would mean that the control device would not detect any offset between the second position and the target position of the splicing apparatus, since the position of the longitudinal edge of the conveyed band strip has not changed and the longitudinal edge of the end of the spliced band is exactly aligned with this position. However, if the second position information indicates a slight positional difference from the first longitudinal edge position information, this slight offset of this second position from the actual position of the longitudinal edge on the splicing apparatus, which corresponds to the first longitudinal edge position, can be detected immediately and a minimal further correction of the splicing apparatus can be made immediately by controlling the drive means via the control device. In this case, a subsequent correction is made. Since this second position is detected almost immediately before the transfer, and since any positional difference is minimal, i.e., in the millimeter range, the correction of the splicing apparatus position can be made immediately and in the shortest possible time, so that the position is corrected when the conveyed band strip is transferred to the splicing apparatus.

The position of the longitudinal edge of the end of the spliced band is known to the control devices, since it corresponds to the position of the detected longitudinal edge of the band strip spliced in the previous cycle, which was previously detected as a conveyed band strip in its longitudinal edge position. Separate detection of the longitudinal edge position of the spliced band strip is therefore not absolutely necessary. Nevertheless, in order to further increase positional accuracy or for control purposes, it may be useful to provide for information detection in this regard as well. For this purpose, it may be provided that a further sensor device for detecting a position of the spliced band strip is provided, which comprises a further sensor apparatus arranged at a longitudinal position of the transport belt, which is set up to detect the position of a longitudinal edge of the spliced band strip, wherein the control device is designed to determine the lateral offset taking into account the detected position of the longitudinal edge of the spliced band. This further sensor device or the further sensor apparatus assigned to the transport belt is therefore used to detect the position of the longitudinal edge of the spliced band strip, i.e. the actual position. The control devices now determine any offset with respect to the first position information and, if provided, the second position information for the longitudinal edge of the conveyed band, taking into account the actual position information for the longitudinal edge of the spliced band. This means that actual position information recorded directly by the corresponding sensor apparatuses is always available for offset determination, enabling highly precise offset determination and thus also alignment movement.

The first and/or the second and/or the further sensor apparatus for detecting the respective longitudinal edge position may comprise at least one optical sensor in the form of a line sensor or a camera or a laser sensor. Such an optical system allows highly accurate detection of the edge position by corresponding evaluation of the sensor signals or the recorded images, wherein the signal curve or the image content always indicates the position of the longitudinal edge with high accuracy, which can be detected by means of suitable evaluation software on the part of the control device. The respective sensors are located vertically above the conveyor belt on which the band strip lies. Of course, sensors other than those mentioned can also be used, as long as they allow accurate edge detection.

In a development of the invention, the first sensor apparatus may comprise a sensor for detecting the leading edge of the band strip being conveyed. This sensor detects the leading edge of the conveyed band strip entering the detection area at an angle to the conveying direction. This signal can be used by the control device as a trigger signal for the start of the upcoming alignment movement. This sensor delivers its signal slightly ahead of the signal from the first sensor apparatus, so that the control devices can already pre-control the alignment components upon receipt of this signal and then, when the first sensor apparatus delivers its signal and any offset is determined immediately thereupon, the corresponding components, i.e., the drive means, are immediately ready for operation and can perform the alignment process.

As described, alignment is achieved by changing the position of the splicing apparatus and, with it, the end of the spliced band resting on it. For a corresponding sliding movement, the splicing apparatus is conveniently mounted so that it can be moved via linear guide means. The splicing apparatus is therefore not mounted in a fixed position on the floor, but can be moved transversely to the conveying direction of the conveyor belt by means of appropriate linear guides. The linear guides may comprise, for example, rollers provided on the splicing apparatus, which run in fixed roller guides. A roller bearing and guide is therefore provided, on which the splicing apparatus is mounted in a movable manner. Two such linear guide means or roller guides and associated rollers are sufficient to guide the splicing apparatus precisely. One or more drive motors are provided for movement, which drive various drive elements such as rollers, spindles, or belts, via which the splicing apparatus is moved along the linear guide means.

A fixed bearing plate may be provided on which the roller guides are mounted. This bearing plate is provided on the floor or on a corresponding fixed fixture and supports the roller guides. Alternatively, it is also conceivable to mount the roller guides directly on the floor side. The roller guides are corresponding guide rails on or in which the rollers are guided and run.

In an expedient development of the invention, it may be provided that the splicing apparatus can additionally be pivoted by an angle of +/−3°, in particular by a maximum of +/−2° and preferably by a maximum of +/−1°, from a basic position aligned with the conveying direction. Accordingly, the splicing apparatus can not only be moved exactly linearly and exactly transversely to the conveying direction of the conveyor belt, but can also be pivoted by a minimal angle if necessary. This makes it possible, for example, to adjust the course of a gap between the trailing edge of the end of the spliced band strip and the leading edge of the approaching band strip. Ideally, this results in a gap that opens marginally from one long side to the other, i.e., the two band strips ideally lie flush against each other at one edge end and then a gap opening only a few arc minutes forms towards the other edge end. This gap is naturally closed during splicing, wherein such a gap or gap geometry is advantageous for a homogeneous splice over the entire splice length. The course of the respective edge can be detected, for example, by means of the first sensor apparatus, since this device detects not only the position of the longitudinal edge but also, of course, the leading and trailing edges of the conveyed edge portion over a certain length, so that their course can be determined from the information provided by the first sensor apparatus on the part of the control device.

If such a small pivot range is to be achieved, the linear guide means are preferably designed to allow pivoting. This means that the linear guide means allow a corresponding marginal pivot range, i.e., for example, the rollers running in the roller guides are guided there with a certain tolerance so that an offset of a few arc minutes is possible.

The drive means themselves conveniently comprise a drive motor connected to a frame of the splicing apparatus. Such a drive motor, preferably a servo motor, is arranged in such a way that, viewed in the conveying direction, it is connected laterally in the center of the frame, so that the pushing torque is applied evenly to the frame and thus to the splicing apparatus itself, and the latter is moved linearly in a homogeneous manner and without any torsional moment via the linear guide means.

An alternative to this provides for the drive means to comprise two separately controllable drive motors, both of which are connected to a frame of the splicing apparatus, with both drive motors being arranged offset from each other in the conveying direction. On the one hand, such an arrangement allows for precise linear displacement, since both drive motors can of course be controlled completely synchronously. On the other hand, it also allows for a marginal pivoting of a few arc minutes by controlling both drive motors differently, resulting in a rotation about a vertical axis.

In addition to the splicing device itself, the invention also relates to a method for operating a splicing device for splicing band strips, in particular adhesive cord band strips, wherein the splicing device comprises:
a conveyor belt transporting a first band portion,
a splicing apparatus comprising a splicing unit in which a leading edge of a band strip conveyed on a conveyor belt is spliced to a trailing edge of a previously spliced band strip to form a spliced band, and comprising a transport belt for conveying the spliced band,
and a sensor device for detecting a position of at least the conveyed band strip, based on which the conveyed band strip and the spliced band are aligned with each other by means of an alignment device.

This method is distinguished in that the sensor device has a first sensor apparatus arranged at a longitudinal position of the conveyor belt, by means of which the position of a longitudinal edge of the band strip is detected, wherein a lateral offset of the detected position of the longitudinal edge with respect to the position of the longitudinal edge of the spliced band is determined by means of a control device, and, upon detection of an offset, the control device activates a drive means of the splicing apparatus, which is mounted so as to be displaceable transversely to the conveying direction of the conveyor belt, in order to align the two longitudinal edges, and the splicing apparatus is displaced to compensate for the offset.

Furthermore, it may be provided that a second sensor apparatus, which is arranged at a longitudinal position of the conveyor belt downstream of the first sensor apparatus in the conveying direction and adjacent to the end of the conveyor belt, also detects the position of the longitudinal edge of the band strip, wherein the lateral offset is determined by means of the control device on the basis of the position of the longitudinal edge detected by the second sensor apparatus.

A further sensor apparatus arranged at a longitudinal position of the transport belt can also detect a position of the spliced band strip, wherein the control device determines the lateral offset taking into account the detected position of the longitudinal edge of the spliced band.

At least one optical sensor in the form of a line sensor or a camera or a laser sensor can be used to detect the respective longitudinal edge position, wherein the list is not exhaustive, i.e., other sensors that allow an exact edge position to be determined can also be used.

In a development of the invention, the leading edge of the conveyed band strip can be detected by means of a sensor of the first sensor apparatus.

Furthermore, it is conceivable that, in order to compensate for an offset, the splicing apparatus is moved linearly and/or pivoted by an angle of +/−3°, in particular by a maximum of +/−2° and preferably by a maximum of +/−1°, from a basic position aligned with the conveying direction.

Finally, one or two separately controllable drive motors, in particular servo motors, can be used as the drive means.

All details, features, and advantages mentioned above with regard to the splicing device apply equally to the method according to the invention, insofar as this is appropriate.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 a schematic representation of a splicing device according to the invention,

FIGS. 2-5 schematic diagrams explaining the transport and splicing process,

FIG. 6 a schematic diagram of the splicing device in a side view showing the first, second, and further sensor apparatuses,

FIG. 7 a top view of the arrangement from FIG. 6,

FIG. 8 a more detailed side view of the splicing apparatus of the splicing device according to the invention,

FIG. 9 a top view of the splicing apparatus from FIG. 8,

FIG. 10 a front view, seen against the conveying direction, of the splicing apparatus from FIG. 8,

FIG. 11 a schematic representation of the first sensor apparatus with a sensor for the movement start process of the alignment and a first sensor for detecting the longitudinal edge position of the band portion,

FIG. 12 a schematic representation of the alignment of the splicing apparatus with a drive means comprising a drive motor,

FIG. 13 a schematic representation of the alignment of the splicing apparatus with a drive means comprising two drive motors, and

FIG. 14 a schematic representation of a layout of a complete apparatus for manufacturing the endless band.

### DETAILED DESCRIPTION OF THE INVENTION

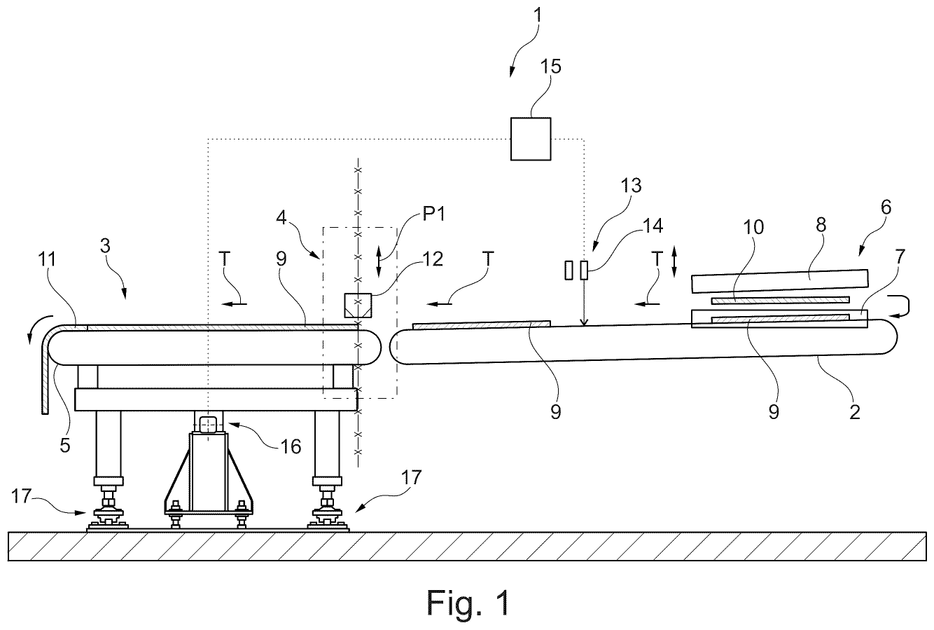

FIG. 1 shows a splicing device 1 according to the invention comprising a conveyor belt 2 guided around rollers and driven in a circulating manner by a drive motor, as well as a splicing apparatus 3 comprising a splicing unit 4 for splicing individual band portions. The splicing apparatus 3 also comprises a transport belt 5 on which the spliced endless band rests and is transported away.

Upstream of the conveyor belt 2 is a cutting device 6 comprising a lower blade 7 and an upper blade 8, by means of which individual band portions 9 are cut from an endless band 10. The individual band portions 9 are picked up on the conveyor belt 2 and transported in the transport direction T to the splicing apparatus 3. The conveyor belt 2 is preferably designed as a circulating belt.

The individual cut band portions 9 are conveyed to the splicing apparatus 3, on which a spliced band 11 rests, the end of which is formed by a previously spliced band portion 9. The leading end of the band portion 9 conveyed via the conveyor belt 2 is spliced to the free end of the band 11 by means of the splicing unit 4, for which purpose an upper splicing tool 12, as shown by the double arrow P1, is moved vertically, whereby the two band portion edges are spliced together. The position of a longitudinal edge of a conveyed band portion 9 is detected by means of a first sensor apparatus 13 comprising a first sensor 14, wherein the information is fed to a control device 15 which, taking into account information on the position of the longitudinal edge of the endless band 11, determines any offset between the two longitudinal edges. If such an offset is determined, the control device 15 controls a drive means 16 by means of which the splicing apparatus 3 can be moved in a direction perpendicular to the conveying direction T, for which purpose the splicing device 3 is mounted so as to be movable via corresponding linear guide means 17.

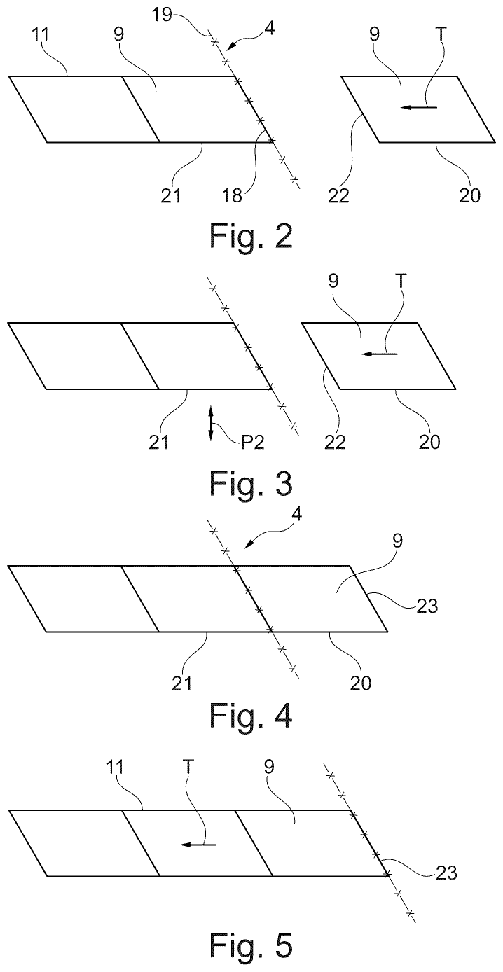

FIGS. 2-5 schematically show the transport and splicing process. Shown is a conveyed band strip 9, which rests on the conveyor belt 2 and is transported in the transport direction T. Also shown is the endless spliced band 11 with its most recently spliced band strip 9, the free trailing edge 18 of which lies directly in the splicing unit 4, i.e., below the splicing tool 12, which is not shown in detail. The splicing line 19 is shown schematically.

At the time shown in FIG. 2, the position of a longitudinal edge 20 of the conveyed band strip 9 is detected by the first sensor apparatus 13, i.e., the first sensor 14. The control device 15 averages any offset to the longitudinal edge 21 of the last spliced band strip 9, wherein this longitudinal edge 21 corresponds to the longitudinal edge of the spliced band 11.

As transport progresses, the transported band strip 9 moves closer and closer to the splicing apparatus 3, which, as shown by the double arrow P2, is shifted transversely to the conveying direction T to compensate for any detected offset until the longitudinal edges 20 and 21 are aligned with each other. This means that the lateral position of the longitudinal edge 21 is adjusted to the position of the longitudinal edge 20. The entire splicing apparatus 3 is displaced in this process, as it is mounted so that it can be displaced transversely via the linear guide means 17, as described above.

In the situation shown in FIG. 4, on the one hand, the splicing apparatus 3 is completely aligned, i.e., the two longitudinal edges 20, 21 are exactly aligned with each other. On the other hand, the conveyed band strip 9 has arrived at its end position, its leading edge 22 is located in the splicing unit 4, and its edge 22 can be spliced to edge 21.

After splicing, the spliced band 11 is transported further along the transport belt 5 by the length of the spliced band strip 9 until the trailing edge 23 of the newly spliced band strip 9 is positioned in the splicing unit 4, whereupon this conveying movement is stopped. The next cycle then begins again with FIG. 2, i.e., a new band strip 9, which was previously cut, is conveyed.

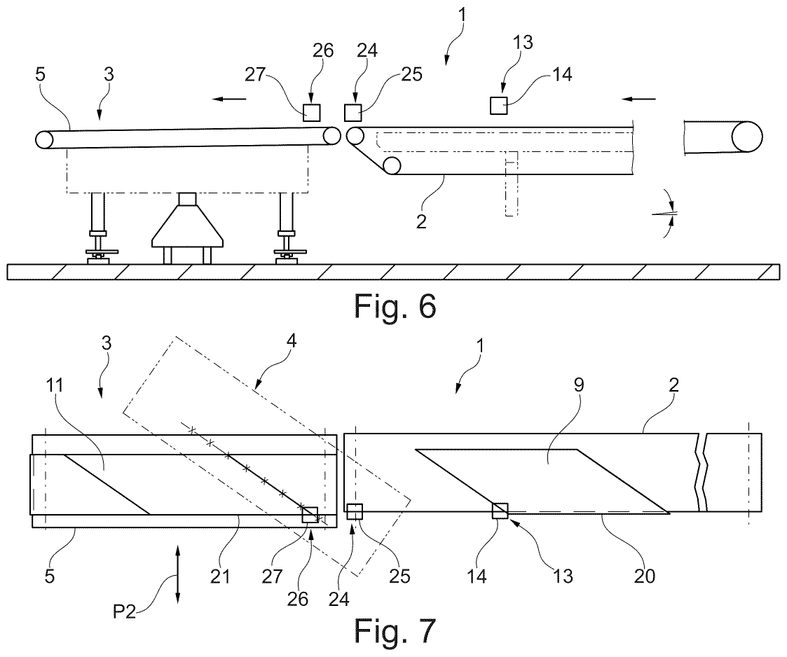

FIG. 6 shows a side view of the splicing device 1 according to the invention. The conveyor belt 2 and the splicing apparatus 3 with its transport belt 5 are shown. FIG. 7 shows a top view of the splicing device from FIG. 6, with the addition of a conveyed band strip 9, the spliced band 11, and the splicing unit 4. The figure also shows that the conveyor belt 2 is slightly narrower than the transport belt 5.

Assigned to the conveyor belt 2 and positioned on one long side thereof is the first sensor apparatus 13 comprising a first sensor 14, by means of which the position of the longitudinal edge 20 of the conveyed band strip 9 is detected. This is located slightly to the side outside the conveyor belt 2.

A second sensor apparatus 24 comprising a second sensor 25 is optionally provided, by means of which the position of the longitudinal edge 20 of the conveyed band strip 9 is also detected. While the first sensor apparatus 13 is spaced slightly further from the end of the conveyor belt 2, the second sensor apparatus 24 is arranged close to the end of the conveyor belt 2. While the first sensor apparatus 13 detects the lateral position of the longitudinal edge 20 at a point that is still somewhat distant from the transfer point of the band strip 9 from the conveyor belt 2 to the transport belt 5, the second sensor apparatus 24 is located directly in the transfer area.

Furthermore, a further sensor apparatus 26 comprising a further sensor 27 is also provided as an option, with which the position of the longitudinal edge 21 of the spliced band 11 or the last spliced band portion 9 is determined. This further sensor apparatus 26 is therefore arranged on the splicing apparatus 3, while the first and second sensor apparatuses 13, 24 are arranged on the conveyor belt 2 or on a frame or similar provided there.

All sensor apparatuses 13, 24, 26 and their respective sensors in 14, 25, 27 comprise or are optical sensors, in particular line sensors; alternatively, cameras or laser sensors can also be used. The respective sensors allow the position of the respective longitudinal edge 20, 21 to be determined precisely in its lateral position, so that the control device 15 is able to detect any offset.

In principle, only the first sensor apparatus 13 is sufficient to achieve the best possible offset correction by laterally shifting the splicing apparatus 3, once the position of the longitudinal edge 21 of the spliced band 11 is known, since it was ultimately detected by the first sensor apparatus 13 at an earlier point in time, namely when the last spliced band strip 9 was still on the conveyor belt 2, and the splicing apparatus 3 was aligned with respect to this edge position. Nevertheless, the use of the second sensor apparatus 24 is also expedient, as this allows a follow-up check of the edge position and thus of the initial alignment to be carried out at a later point in time. Immediately after detecting the edge position via the first sensor apparatus 14, the control device 15 can therefore, if it detects any offset, align the splicing apparatus 3 and move it transversely via the drive means 16 so that the longitudinal edges 20, 21 are aligned with each other at this point in time. An edge position check can be performed via the second sensor apparatus 24, which again detects the position of the longitudinal edge 20 of the conveyed band strip 9. If this position information coincides with the position information previously detected by the first sensor apparatus 13, no further end correction is necessary. However, if they differ marginally, the control device 15 can detect any marginal offset again and immediately move the splicing apparatus 3 via the drive means 16 in order to compensate for this offset.

As described, the position of the longitudinal edge 21 is basically known. However, in order to check this position information again, the additional sensor apparatus 26 may be provided with an additional sensor 27, which detects this position again, wherein this information can also be taken into account by the control devices 15.

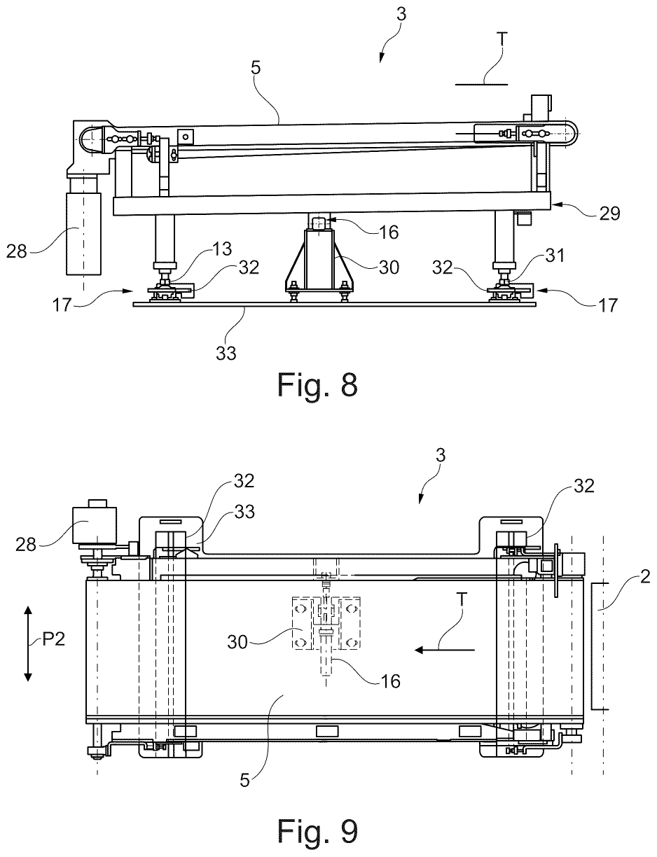

FIG. 8 shows a more detailed side view of the splicing apparatus 3, while FIG. 9 shows a top view of the splicing apparatus 3 from FIG. 8. The figure shows the circulating transport belt 5, which is guided over suitable roller guides and can be driven in a circulating manner by means of a drive motor 28, so that the upper run moves in the transport direction T. The splicing apparatus 3 comprises a frame 29 on which the transport belt 5 is mounted, wherein the frame 29 is linearly movable via the two linear guides 17 and can be displaced transversely to the transport direction T, as already described. This is achieved by means of the drive means 16, which is preferably a drive motor and in particular a servo motor, which is arranged on a separate support bracket 30 and is coupled to the frame 29.

The linear guide means 17 comprise rollers 31 arranged on the frame 29, which run and are guided on or in corresponding roller guides 32, which in this case are arranged on a bearing plate 33, which in turn is fixedly mounted on the floor. The drive means 16 allows for a corresponding transverse displacement, as shown by the double arrow P2, so that the splicing apparatus 3 can be adjusted transversely to the transport direction T and, consequently, also with respect to the end of the conveyor belt 2, which is still indicated on the right in FIG. 9. This allows the necessary offset compensation to be made.

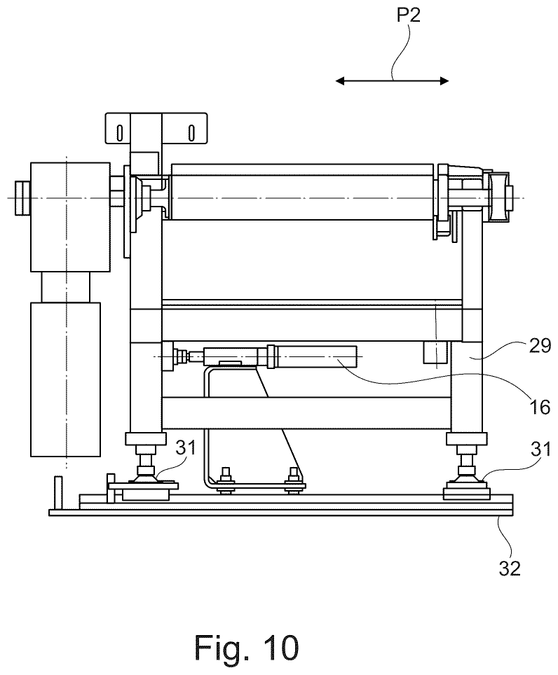

A corresponding front view, seen against the conveying direction T, is shown in FIG. 10. The frame 29 is visible, seen in the transverse direction, guided via two separate arrangements of rollers 31 on the rail-like roller guide 32, so that a total of 4-point support and guidance is achieved.

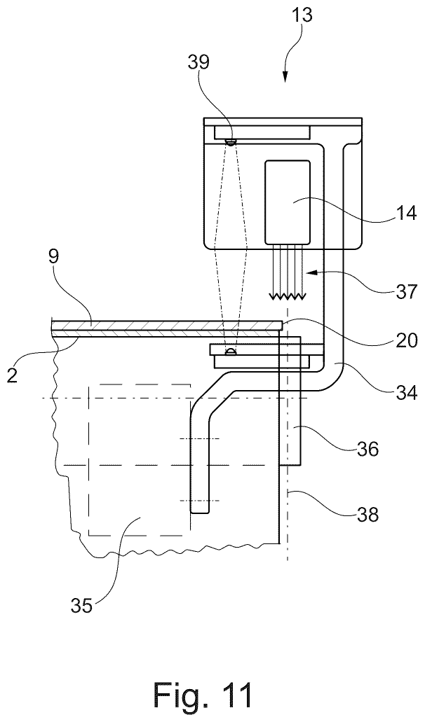

FIG. 11 shows a schematic representation of the first sensor apparatus 13. This is arranged in a fixed position on a frame 35 of the conveyor belt 2 via a corresponding holder 34. It is located above the conveyor belt 2, which is guided via deflection rollers 36 provided on both sides and on which a cut band strip of belt 9 lies. In the example shown, the longitudinal edge 20 of the band strip protrudes slightly beyond the edge of the conveyor belt 2, but this is not necessary; the band strip can also be flush with the edge or lie further inward.

The first sensor apparatus 13 is located above this longitudinal edge area. It comprises, on the one hand, the first sensor 14, which is aligned in such a way that its measuring field 37, as indicated by the arrows, detects the longitudinal edge 20 in any case. This means that the sensor signals supplied by sensor 14, whether they are scanning or reflection signals or recorded images, can be used to precisely detect the position of the longitudinal edge and determine it in relation to a reference edge 38 shown here, which is preferably done by the control device 15. This reference edge 38 is defined by the system and determined by the first sensor apparatus 13.

A sensor 39 is also shown, which is integrated into the first sensor apparatus 13 and is used to detect the leading edge 22 of the band strip 9. The leading edge 22 is detected by the sensor 39 slightly ahead of the longitudinal edge 20. As soon as the edge 22, which runs at an angle as shown in FIGS. 2-5, is detected and the control devices 15 receive this signal, they can initiate any alignment process that may be pending. For this purpose, the drive means 16, for example, can already be controlled in a corresponding preparatory manner or the like. As soon as the longitudinal edge 20 is detected by the first sensor apparatus 13 and the control devices 15 determine any offset to the longitudinal edge 21, the control device 15 can then immediately control the drive means 16 and move the splicing apparatus 3 transversely to compensate for the offset. This allows for pre-control.

As the band strip 9 continues to be conveyed, it enters the area of the second sensor apparatus 24, which detects the edge 20 again. This sensor apparatus 24 also has a corresponding second sensor 25, preferably the same sensor as the sensor apparatus 13, wherein the detected edge position is again evaluated by the control device 15 and, despite the compensation already having taken place, any remaining marginal offset can be determined. If such an offset exists, the control device 15 again controls the drive means 16 in order to compensate for it immediately.

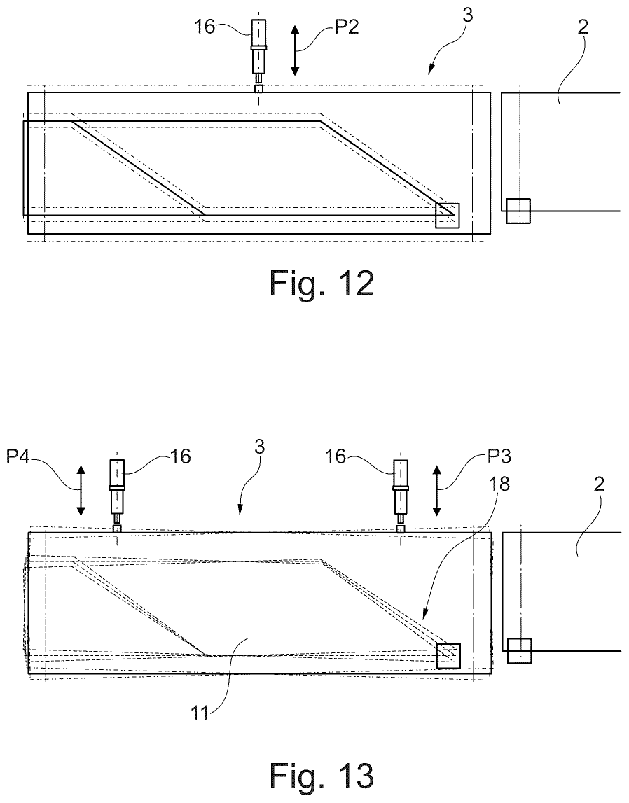

FIG. 12 shows a schematic representation in the form of a top view of the splicing apparatus 3, in which only one drive means 16, i.e., only one drive motor, is provided. This is preferably arranged longitudinally in the center, as seen in the conveying direction, relative to the frame 29. In such a design with only one drive means 16, i.e., only one actuator, the splicing apparatus 3 is moved synchronously and homogeneously via both linear guides, as indicated by the double arrow P2.

FIG. 13, on the other hand, shows a variant in which two separate drive means 16 are provided, i.e., two separate drive motors or servo motors that can be controlled separately. They are offset relative to the longitudinal center of the frame 29. When both are controlled synchronously, this allows the splicing apparatus 3 to be moved synchronously via both linear guides 17. Alternatively, it is also conceivable to use this to achieve a marginal pivot movement, as shown in FIG. 13. For this purpose, the two drive means 16 or drive motors are, for example, controlled slightly in opposite directions so that one drive means 16 pushes while the other drive means 16 pulls, or different travel distances are specified, etc. This is shown by the separate double arrows P3, P4. In any case, this allows a certain amount of pivoting or tilting of the splicing apparatus 3 relative to the conveying direction T of the conveyor belt 2, which is also only indicated here, as shown in FIG. 13. This can be used to achieve a marginal tilting or pivoting of the trailing edge 18 of the spliced band 11, as indicated in FIG. 13. This allows the shape of the gap between the two edges 18, 22 resulting in the splicing unit 4 immediately before splicing, when both band portions 9 to be spliced are at rest, to be adjusted. This should preferably widen slightly from one end to the other, i.e., the edge 22 of the conveyed band strip 9 should be adjacent to the trailing tip of the band 11, and the gap should widen slightly from there to the other edge end. This minimal tilt or pivot, which is only a few arc minutes, can be made possible by the two linear guides 17, which can have a certain tolerance in this respect, so that the desired adjustment can be made via the two drive means 16. The course of the edges 18, 22 can be detected by the first sensor apparatus 13 or its sensor 14, since these edges run through the detection range of the sensor 14 and the control device 15 can determine the edge course from this.

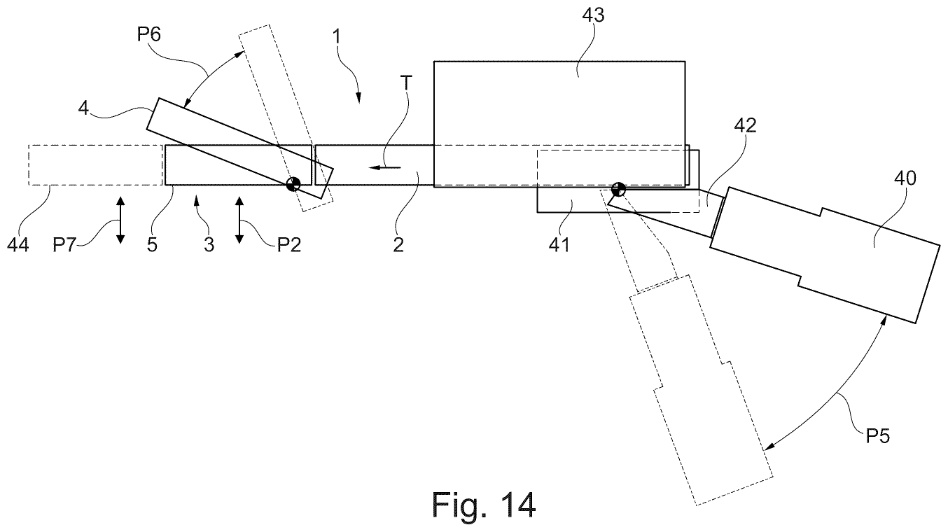

Finally, FIG. 14 shows a layout of a plant for manufacturing such an endless band, which is further processed after its manufacture. Shown is an unwinding station 40 from which the cord band to be processed is obtained. In the unwinding station 40, the roll of cord band to be processed is hooked into a suitable holder and unwound. The unwinding station 40 can be pivoted, as shown by the double arrow P5, in order to achieve different cutting angles.

The unwinding station 40 is followed by a cutting device 41, in which the band portions 9 are cut using suitable knives. For example, impact knives comprising a fixed lower knife and a vertically movable upper knife are used for this purpose. In order to convey the cord band fed by the unwinding station 40, which is fed via a transport device 42, through the cutting device 41, a gripping device 43 is provided which grips the leading edge of the cord band and pulls it through the cutting device 41.

Downstream of the cutting device 41 is the splicing device 1 according to the invention. Immediately after cutting, the cut band strip 9 lies on the conveyor belt 2, which transports the band strip 9 in the conveying direction T to the splicing apparatus 3, which, as described and indicated by the double arrow P2, is fundamentally transversely displaceable. The pivotability of the splicing unit 4 is also shown, as indicated by the double arrow P6, in order to be able to adapt to different cutting angles. The spliced band 11 located on the transport belt 5 can be transferred from the transport belt 5 to an optional additional transport belt 44, which is also part of the splicing device 1 and can be moved transversely together with the splicing apparatus 3, as indicated by the double arrow P7. Such an additional transport belt 44 may be provided, but is not mandatory. The endless band 11 is then wound up via a winding station not shown in detail, wherein the winding station may be preceded by a slitter, which separates the endless band into two partial belts, as well as a repair belt or a covering apparatus, if necessary.

While specific embodiments of the invention have been shown and described in detail to illustrate the inventive principles, it will be understood that the invention may be embodied otherwise without departing from such principles.

I claim:

1. A splicing device for splicing band strips, in particular adhesive cord band strips, comprising
a conveyor belt transporting a first band portion,
a splicing apparatus comprising a splicing unit, in which a leading edge of a band strip conveyed over the conveyor belt is spliced with a trailing edge of a previously spliced band strip to form a spliced band, and comprising a transport belt for conveying the spliced band,
and a sensor device for detecting a position of at least the conveyed band strip, based on which the conveyed band strip and the spliced band can be aligned with each other by means of an alignment device,
wherein the sensor device has a first sensor apparatus arranged at a longitudinal position of the conveyor belt, which is designed to detect the position of a longitudinal edge of the band strip, wherein a control device is provided which is designed to determine a lateral offset of the detected position of the longitudinal edge with respect to the position of the longitudinal edge of the spliced band, and which, when an offset is determined, can be used to control a drive means of the splicing apparatus, which is mounted so as to be displaceable transversely to the conveying direction of the conveyor belt, in order to align the two longitudinal edges.

2. The splicing device according to claim 1, wherein the sensor device comprises a second sensor apparatus which is arranged at a longitudinal position of the conveyor belt downstream of the first sensor apparatus in the conveying direction adjacent to the end of the conveyor belt and is also designed to detect the position of a longitudinal edge of the band strip, wherein the control device is designed to determine a lateral offset of the position of the longitudinal edge detected by the second sensor apparatus with the position of the longitudinal edge of the spliced band and is designed to control the drive means when an offset is detected.

3. The splicing device according to claim 1, wherein a further sensor device is provided for detecting a position of the spliced band strip, which comprises a further sensor apparatus arranged at a longitudinal position of the conveyor belt, which is designed to detect the position of a longitudinal edge of the spliced band strip, wherein the control device is designed to determine the lateral offset taking into account the detected position of the longitudinal edge of the spliced band strip.

4. The splicing device according to claim 1, wherein the first and/or the second and/or the further sensor apparatus for detecting the respective longitudinal edge position comprises at least one optical sensor in the form of a line sensor or a camera or a laser sensor.

5. The splicing device according to claim 1, wherein the first sensor apparatus comprises a sensor for detecting the leading edge of the conveyed band strip.

6. The splicing device according to claim 1, wherein the splicing apparatus is mounted so as to be displaceable via linear guide means.

7. The splicing device according to claim 6, wherein the linear guide means comprise rollers provided on the splicing apparatus, which run in or on position-fixed roller guides.

8. The splicing device according to claim 7, wherein a fixed bearing plate is provided, on which the roller guides are provided, or in that the roller guides are fixed to the floor.

9. The splicing device according to claim 6, wherein the splicing apparatus can additionally be pivoted by an angle of +/−3°, in particular by a maximum of +/−2° and preferably by a maximum of +/−1°, from a basic position aligned with the conveying direction.

10. The splicing device according to claim 9, wherein the linear guide means are designed to enable the pivoting.

11. The splicing device according to claim 1, wherein the drive means comprise a drive motor connected to a frame of the splicing apparatus.

12. The splicing device according to claim 1, wherein the drive means comprise two separately controllable drive motors, both of which are connected to a frame of the splicing apparatus, wherein both drive motors are arranged offset from each other in the conveying direction.

13. A method for operating a splicing device for splicing band strips, in particular adhesive cord band strips, wherein the splicing device comprises:
a conveyor belt transporting a first band portion,
a splicing apparatus comprising a splicing unit, in which a leading edge of a band strip conveyed over the conveyor belt is spliced with a trailing edge of a previously spliced band strip to form a spliced band, and comprising a transport belt for conveying the spliced band,
and a sensor device for detecting a position of at least the conveyed band strip, on the basis of which the conveyed band strip and the spliced band are aligned with each other by means of an alignment device,
wherein the sensor device has a first sensor apparatus arranged at a longitudinal position of the conveyor belt, by means of which the position of a longitudinal edge of the band strip is detected, wherein a lateral offset of the detected position of the longitudinal edge with the position of the longitudinal edge of the spliced band is determined, and, if an offset is detected, a drive means of the splicing apparatus, which is mounted so as to be displaceable transversely to the conveying direction of the conveyor belt, is activated via the control device in order to align the two longitudinal edges and the splicing apparatus is moved to compensate for the offset.

14. The method according to claim 13, wherein a second sensor apparatus, which is arranged at a longitudinal position of the conveyor belt downstream of the first sensor apparatus in the conveying direction and adjacent to the end of the conveyor belt, also detects the position of the longitudinal edge of the band strip, wherein the lateral offset is determined by means of the control device on the basis of the position of the longitudinal edge detected by the second sensor apparatus.

15. The method according to claim 13, wherein a further sensor apparatus, which is arranged at a longitudinal position of the transport belt, detects the position of the spliced band, wherein the control device determines the lateral offset taking into account the detected position of the longitudinal edge of the spliced band.

16. The method according to claim 13, wherein at least one optical sensor in the form of a line sensor or a camera or a laser sensor is used to detect the respective longitudinal edge position.

17. The method according to claim 13, wherein the leading edge of the conveyed band strip is detected by means of a sensor of the first sensor apparatus.

18. The method according to claim 13, wherein, in order to compensate for an offset, the splicing apparatus is moved linearly and/or pivoted by an angle of +/−3°, in particular of a maximum of +/−2° and preferably of a maximum of +/−1°, from a basic position aligned with the conveying direction.

19. The method according to claim 13, wherein one or two separately controllable drive motors, in particular servo motors, are used as drive means.
